(19) United States
(12) Patent Application Publication
(10) Pub. No.: US 2012/0019133 A1
(43) Pub. Date: Jan. 26, 2012

(54) LOW POWER CERAMIC GAS DISCHARGE METAL HALIDE LAMP WITH REDUCED GLOW VOLTAGE

(75) Inventors: William Graham, Painted Post, NY (US); Ray Gibson, Bath, NY (US)

(73) Assignee: KONINKLIJKE PHILIPS ELECTRONICS N.V., EINDHOVEN (NL)

(21) Appl. No.: 13/142,547

(22) PCT Filed: Dec. 16, 2009
(86) PCT No.: PCT/IB2009/055790

§ 371 Date: Jun. 28, 2011

(30) Foreign Application Priority Data
Dec. 30, 2008 (US) 61141276
Mar. 27, 2009 (US) 61163961

(51) Int. Cl. H01J 61/16; H01J 61/33

(52) U.S. Cl. 313/573

(57) ABSTRACT

A low power ceramic gas discharge metal halide (CDM) lamp 10 capable of retrofitting into existing low power HPS lamp fixtures, the CDM lamp 10 having an elliptically-shaped ceramic discharge vessel 12 containing a mixture of the rare gases neon and argon at a fill pressure of at least 400 mbar, and a pair of electrodes (17, 18) extending into the discharge vessel 12, the electrodes (17, 18) having an electrode clearance ratio E=D1/D2 of at least 0.36, where D1 is the shortest distance from an electrode (17) tip to the inner wall of the central portion 13 of the discharge vessel 12 and D2 is the distance between the discharge electrodes 17 and 18.

### BACKGROUND OF THE INVENTION

This invention relates to low power (up to 150 W) ceramic gas discharge metal halide (CDM) lamps, and, more particularly, relates to such lamps which utilize a ceramic discharge vessel and a rare gas mixture in the discharge space.

Low power CDM lamps have a more pleasing white light emission than the yellowish cast of the older high pressure sodium (HPS) lamps in widespread use in North America, which makes these CDM lamps attractive candidates for retrofitting into existing low power HPS lamp fixtures in North America. The major problem to overcome is the glow voltage of the CDM lamps and the available open circuit voltage (OCV) of the existing HPS ballasts to sustain that glow.

The ignition process of high intensity discharge (HID) lamps such as high pressure sodium (HPS) lamps consists of voltage breakdown resulting in a glow discharge and then a transition to a full plasma arc discharge. In order for the glow-to-arc transition to occur, sufficient open circuit voltage (OCV) from the ballast must be available.

The glow voltage of typical low power (75 W-100 W) CDM lamps with cylindrical polycrystalline alumina (PCA) ceramic discharge vessels is greater than 200V, whereas the ANSI-specified minimum OCV available from the HPS ballast is 110VRMS. Thus, the available OCV of the HPS ballasts is insufficient to transition the glow discharge to a full arc discharge, and the low power CDM lamps that are made today will not retrofit into existing HPS lamp fixtures.

According to J. F. Waymouth in “The Glow-To-Thermionic-Arc Transition”, Journal of IES, Summer 1987, pp 166-180, the peak of the open circuit voltage (OCV) of a starting ballast for a gas discharge lamp must be at least 15% greater than the glow voltage of the lamp. The ASNI specification for minimum available OCV in existing low power HPS ballasts in North America is 110VRMS. Therefore, for the above ANSI-specified OCV, the peak OCV is 156V and the maximum target glow voltage is 132V.

The main factor that determines the glow voltage of a lamp is the electrode work function. The electrodes of both HPS and CDM are tungsten which has a work function of 4.5 eV. The major reason the HPS lamps have a much lower glow voltage is because they use an emission coating on the electrodes to lower the work function of their electrodes. These solid state emitters can not be used in the CDM lamps because the emitter will react with the halide salts, depleting the emitter as well as causing early blackening of the discharge vessel.

If solid state emitters cannot be utilized then other factors need to be changed in order to achieve a lower glow voltage.

U.S. Pat. No. 6,943,498 discloses a CDM lamp having a cylindrically-shaped discharge vessel which employs a neon gas or a neon-based gaseous mixture as a starting-assistance rare gas, at a filling pressure of from 13-40 kPa (130-400 mbar) in order to lower the starting voltage of the lamp. The outer bulb includes a starting-assistance conductor, which runs along the outer surface of the discharge vessel. This starting-assistance conductor promotes arc discharge from the tip portions of the electrodes after the discharging starts.

However, the use of a starting-assistance conductor requires additional hardware and process steps, thus increasing the complexity and manufacturing costs of such lamps.

### SUMMARY OF THE INVENTION

It is desirable to produce a low power CDM lamp that is able to start on an HPS ballast without the aid of solid state emitters on the electrodes and without the aid of starting-assistance conductors inside the lamp by adjusting a variety of design features of the PCA discharge vessel, including the shape of the discharge vessel, the placement of the electrodes, the rare gas fill, and the filling pressure.

According to various embodiments and implementations of the claimed invention, a low power ceramic gas discharge metal halide (CDM) lamp is characterized by a rounded, e.g., elliptically-shaped, discharge vessel, by an electrode clearance ratio of at least 0.36, and by a rare gas fill of neon/argon at a fill pressure of at least 400 mbar. The term ‘electrode clearance ratio’ as used herein means the ratio E between the shortest distance D1 from an electrode tip to the inner wall of the discharge vessel and the distance between the electrodes D2, or D1/D2.

The rare gas mixture is predominantly neon, remainder argon. A trace amount (e.g., 2.5 MBq/l) of radioactive krypton (Kr⁸⁵) may be employed to enhance starting in severe conditions.

In its broadest aspect, the invention focuses on a low power (up to about 150 W) ceramic gas discharge metal halide (CDM) lamp that includes:

a polycrystalline alumina (PCA) ceramic discharge vessel of rounded shape, the discharge vessel having an inner wall enclosing a discharge space, the discharge space having a fill capable of sustaining a discharge between the electrodes, the fill comprising a mixture of rare gases and at least one metal halide; and

a pair of electrodes extending into the discharge space, the electrodes having an electrode clearance ratio E=D1/D2, where D1 is the shortest distance from an electrode tip to the inner wall of the discharge vessel and D2 is the distance between electrodes;

characterized in that the rare gas is a mixture of neon and argon, in that the rare gas mixture is present at a pressure of at least 400 mbar, and in that the electrode clearance ratio E is at least 0.36.

According to some embodiments of the invention, the electrode clearance ratio is from about 0.4 to 0.5, and the rare gas fill pressure is from about 400 mbar to 500 mbar.

According to other embodiments of the invention, the rare gas mixture of neon and argon comprises from about 99.3 to 99.8 percent neon and from about 0.7 to 0.2 percent argon.

According to one particular embodiment of the invention, the rare gas mixture contains a trace amount of radioactive krypton.

This invention is suitable to any low power (up to and including 150 W) CDM lamp that is intended for retrofit onto low power HPS systems in North America. These products would expand the growing yellow-to-white light retrofit market for the lower powers.

### BRIEF DESCRIPTION OF THE DRAWINGS

These and other aspects of the invention will be further elucidated with reference to the Figures, in which:

FIG. 1 shows a low power ceramic gas discharge metal halide (CDM) lamp according to one embodiment of the invention;

FIG. 2a shows the elliptically-shaped discharge vessel of the lamp of FIG. 1;

FIG. 2b shows a cylindrically-shaped discharge vessel;

FIG. 3 is a boxplot of glow voltage versus rare gas fill for three sets of lamps of the type shown in FIG. 1 having three different rare gas fills;

FIG. 4 is a boxplot of glow voltage versus rare gas fill pressure for a set of lamps of the type shown in FIG. 1 having a rare gas fill of a mixture of neon and argon; and

FIG. 5 is a boxplot of glow voltage versus electrode clearance ratio for a set of lamps of the type shown in FIG. 1 having a rare gas fill of a mixture of neon and argon;

The Figures are diagrammatic and not drawn to scale. The same reference numbers in different Figures refer to like parts.

### DETAILED DESCRIPTION

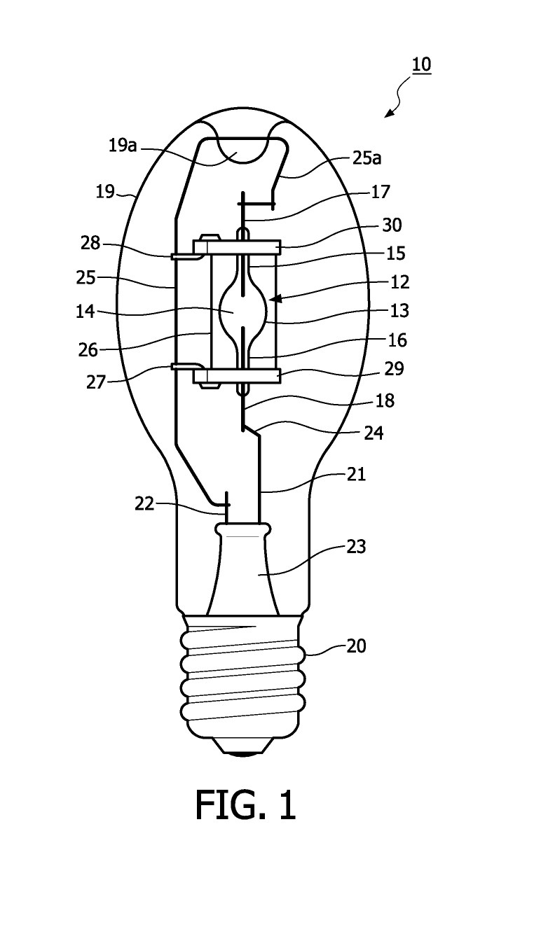

FIG. 1 shows a low power ceramic gas discharge metal halide (CDM) lamp 10 according to one embodiment of the invention, having a PCA discharge vessel 12 including a central elliptically-shaped portion 13 enclosing a discharge space 14, and a pair of tube-shaped end portions 15 and 16. A pair of discharge electrodes 17 and 18 extends through and is supported by the end portions 15 and 16 of the discharge vessel 12 into the discharge space 14. An outer bulb-shaped envelope 19 surrounds the discharge vessel 12 and discharge electrodes 17 and 18 and is sealed to a metal screw base 20 to provide an air-tight enclosure.

Electrical leads 21 and 22 are electrically connected to base 20 and extend through and are supported by glass press seal 23. Electrical connection between discharge electrode 18 and external electrical lead 21 is provided by supporting element 24. Electrical connection between discharge electrode 17 and external electrical lead 22 is provided by frame member 25, via an extension 25a. Extension 25a wraps around a dimple 19a extending inwardly from the upper end of envelope 19 to provide additional support, and then extends downward to connect electrically with discharge electrode 17. A protective shroud 26, which surrounding discharge vessel 12, is supported by frame member 25 via brackets 27 and 28 and straps 29 and 30.

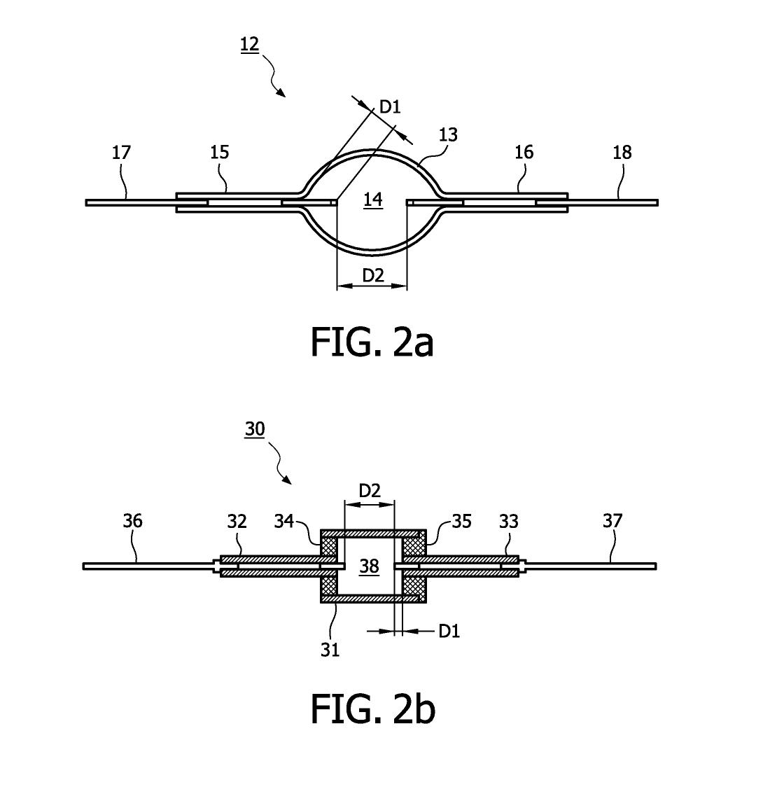

FIG. 2a shows the gas discharge 12 vessel for the lamp of FIG. 1. The clearance ratio E is defined by the shortest distance D1 from the tip of an electrode (17) the inner wall of the central portion of the discharge vessel 13, divided by D2, the distance between the discharge electrodes 17 and 18.

For comparison, FIG. 2b shows a gas discharge vessel 30 of the prior art having a cylindrically-shaped central portion 31, and tubular end portions 32 and 33 sealed into end plugs 34 and 35 to form a discharge space 38. Discharge electrodes 36 and 37 extend through the end portions 32 and 33 into the interior of the discharge space 38. The clearance ratio E is smaller than for the elliptically-shaped vessel of FIG. 2a, due to the smaller distance D1 between the tip of the discharge electrode (37) and the inner wall of the end cap (35).

The discharge space 14 is filled with a starting gas of a mixture of rare gases and a chemical filling of metal halide salts chosen from sodium, calcium, magnesium, indium, manganese, thallium, the rare earths, and mercury, e.g., Na/Tl/Ca/Ce (18.2/3.5/75.8/2.5 Mol %); Mercury: 8-10 mg.

The starting gas mixture is a Penning mixture of about 99.3 to 99.7 mole percent neon, and about 0.7 to 0.2 mole percent argon, e.g., 99.7% neon and 0.3% argon.

The goal of starting and completing the glow-to-arc transition is achieved by sufficiently heating the electrodes to a thermionic state. During the glow stage the electrodes are heated by ion bombardment.

A sufficiently low glow voltage can be achieved by using a combination of rare gas type, rare gas pressure, electrode distance and the shape of the PCA discharge vessel. By using a rare gas that has a higher secondary electron emission coefficient the rate of ion bombardment after the initial breakdown can be increased. While increasing the rare gas fill pressure increases the amount of voltage required for initial breakdown, it also reduces the glow voltage of the lamp.

The shape of the discharge vessel has an effect due to the wall losses that can occur during starting. The closer the electrodes are to the discharge vessel wall the more electrons are lost to reactions at the wall and not available to contribute to the transition to a full arc discharge. None of these parameters alone can lower the glow voltage sufficiently, but a combination of all of the parameters will, resulting in a low power CDM lamp that ignites on a North American low power (e.g., 35 W-150 W 55V) HPS system.

A series of 100 W 55V CDM lamps of the type described in FIGS. 1 and 2 were fabricated in sets having differing design characteristics, in order to determine the conditions under which a successful ignition in a North American low power HPS system having an ANSI-specified minimum available OCV of 110VRMS and the maximum target glow voltage of 132V. The lamps were seasoned for 20 hours before glow voltages were measured.

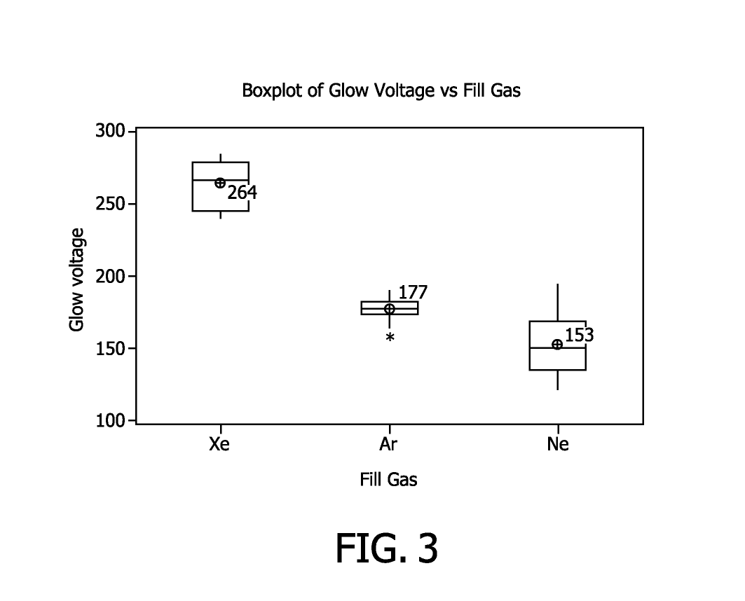

FIG. 3 is a boxplot showing the variation of glow voltage with different fills of starting gas in the discharge vessel. In first and second sets of lamps, the fills were Argon and Xenon, dosed as Ar/Kr⁸⁵ and Xe/Kr⁸⁵ gas mixtures, respectively. The K⁸⁵ is used to aid breakdown and is only present at trace amounts. In a third set of lamps, the fill was a NeAr penning mixture (99.7% Neon 0.3% Argon). All of the lamps had discharge vessel filling pressures between 200 mbar and 300 mbar. It can be seen in FIG. 3 that by changing the fill gas to a penning mixture, the glow voltage of the lamps was significantly lowered, and results in the lowest mean glow voltage of the three sets.

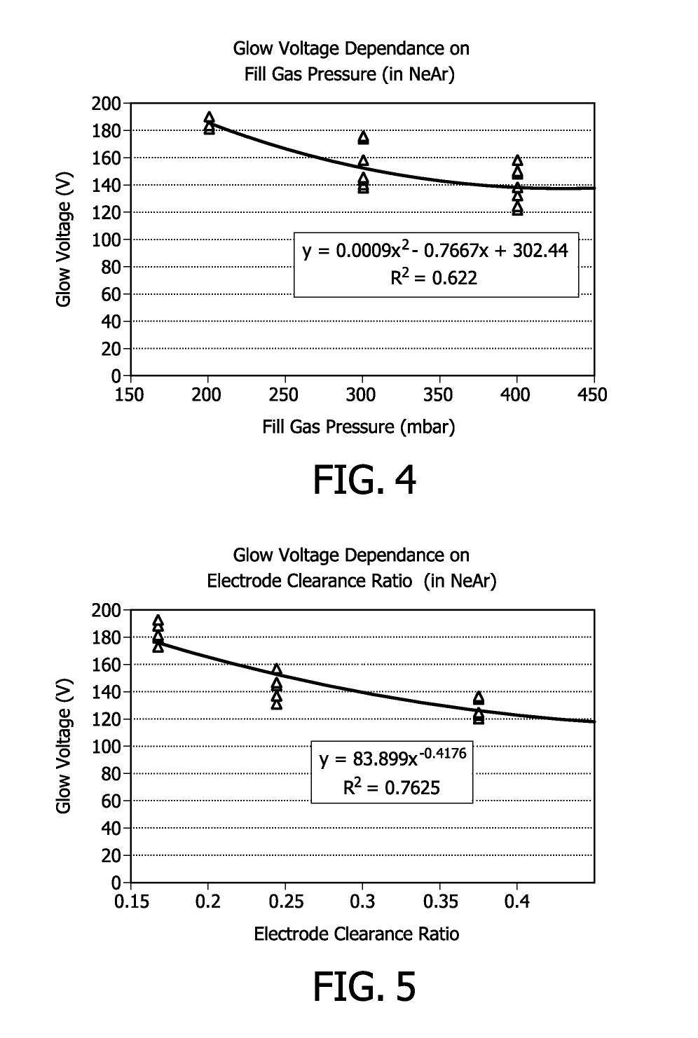

Knowing now that a fill gas consisting of neon yields the lowest glow voltage, the next step was to determine the dependence of glow voltage on the fill pressure. FIG. 4 is a boxplot showing glow voltages for three sets of lamps having the same penning mixture used in the third set of lamps of FIG. 3, each set having a different fill pressure of 200, 300 and 400 mbar, respectively. FIG. 4 shows that as the fill pressure of neon is increased the glow voltage is decreased.

The next design aspects to analyse were the shape of the discharge vessel and the distance of the electrodes to the discharge vessel walls, and because there are two different shapes of discharge vessel used in these experiments (see FIG. 2a) the traditional aspect ratio of linear distance from the electrode tip perpendicular to the wall by the electrode distance is not used. Instead a ratio of the shortest distance from the electrode tip to any wall D1 by the distance between electrodes D2, referred to here as electrode clearance ratio E is used.

For the cylindrically-shaped vessel used in these tests, the shortest distance from the end of the electrode to a wall is 1 mm (the tip-to-bottom distance) and the electrode distance is 6 mm yielding an electrode clearance ratio of 0.17. Additional tests were performed with two sets of lamps having different elliptically-shaped vessels. The first set had vessels with a distance D1 of 2.6 mm and a distance D2 of 11 mm, yielding an electrode clearance ratio E of 0.24. The second set had vessels with a distance D1 of 9 mm and a distance D2 of 3.25 mm, yielding an electrode clearance ratio of 0.36. FIG. 5 is a boxplot showing the glow voltages for the sets having the three different electrode clearance ratios.

The discharge vessel parameters that yield the low power 100 W CDM lamp that is able to retrofit on a 100 W HPS S54 system consist of an elliptical shaped discharge vessel with a rare gas penning mixture of neon/argon at a pressure of at least 400 mbar and an electrode clearance ratio of at least 0.36. This combination has been measured to have an average glow voltage of 132V. The 100 W 55V CDM lamp described will ignite on an HPS ballast at −10% primary (108V). The successful embodiment was demonstrated for 100 W but can be translated to the 35 W, 50 W, 70 W and 150 W lamps.

An enhancement to this product is the ability to create it mercury free. Zinc has been experimented with in the attempt to make mercury free CDM products. To major road block with zinc is that it is difficult to achieve the 100V or greater required for traditional CDM products. The products however only need 55V and this is achievable with zinc as a replacement for mercury, for example, as discussed in U.S. Pat. No. 7,218,052 and U.S. Patent Application Publication No. 20070120458, both incorporated herein by reference.

These techniques for lowering the glow voltage are not limited to only the lamps described herein and can be applied to any CDM lamp that is required to reduce the glow voltage.

The approach disclosed herein is applicable to any low power (for example, up to and including 150 W) CDM lamp that is intended for retrofit on to HPS systems in North America. The potential is great for a family of low power CDM retrofit products as there are 100's of thousands of installed HPS lamps in these powers. The ability to lower the glow voltage of ceramic metal halide lamps could also be useful in future electronic ballast designs. The buss voltage of the electronic ballast is equivalent to the OCV and is required to be high enough to transition lamps through the glow to arc transition. There is a potential to reduce the size of the electronic ballasts and/or improve the efficiency of the ballast if a lower buss voltage is required to be maintained.

The invention has necessarily been described in terms of a limited number of embodiments. From this description, other embodiments and variations of embodiments will become apparent to those skilled in the art, and are intended to be fully encompassed within the scope of the invention and the appended claims.

1. A low power ceramic gas discharge metal halide (CDM) lamp, comprising:
a polycrystalline alumina (PCA) ceramic discharge vessel of rounded shape, the discharge vessel having an inner wall enclosing a discharge space, the discharge space having a fill capable of sustaining a discharge between the electrodes, the fill including a mixture of rare gases, mercury and at least one metal halide; and
a pair of electrodes extending into the discharge space, the electrodes having an electrode clearance ratio E=D1/D2, where D1 is the shortest distance from an electrode tip to the inner wall of the discharge vessel and D2 is the distance between electrodes;
characterized in that the rare gas is a mixture of neon and argon, in that the rare gas mixture is present at a pressure of at least 400 mbar, and in that the electrode clearance ratio E is at least 0.36.

2. The CDM lamp of claim 1 in which the discharge vessel is a substantially elliptically-shaped vessel.

3. The CDM lamp of claim 1 in which the rare gas mixture of neon and argon comprises from about 99.3 to 99.7 mole percent neon and from about 0.7 to 0.2 mole percent argon.

4. The CDM lamp of claim 1 in which the pressure of the rare gas mixture is from about 400 mbar to about 500 mbar.

5. The CDM lamp of claim 1 in which the electrode clearance ratio E is from about 0.4 to 0.5.

6. The CDM lamp of claim 1 in which the rare gas mixture contains a trace amount of radioactive krypton.
